(19) United States
(12) Patent Application Publication
(10) Pub. No.: US 2011/0170159 A1
(43) Pub. Date: Jul. 14, 2011

(54) LIGHT LIMITING WINDOW

(75) Inventors: Ariela Donval, Rosh-Haayin (IL); Boaz Nemet, Tel-Aviv (IL); Dornon Nevo, Ra'anana (IL); Moshe Oron, Rehivet (IL)

(73) Assignee: KIloLambda Technologies Ltd., Tel Aviv (IL)

(21) Appl. No.: 13/000,149

(22) PCT Filed: Jun. 18, 2009
(86) PCT No.: PCT/IB09/06006

§ 371 Date: Mar. 11, 2011

Related U.S. Application Data
(60) Provisional application No. 61/075,073, filed on Jun. 24, 2008.

(51) Int. Cl. G02F 1/17

(52) U.S. Cl. 359/241

(57) ABSTRACT

A passive optical power limiting window comprising a transparent optical input element, a transparent optical output element, and a power-limiting element disposed between these input and output elements for transmitting optical light from these input elements to these output elements, these optical power-limiting elements comprising an optical-limiting solid mixture containing particles of at least one material that produces reversible thermal changes in response to light above a predetermined optical power level, thereby changing the optical transmission properties of these power-limiting elements.

### FIELD OF THE INVENTION

The present invention relates to light limiting device, and more particularly, to a light limiting passive device and to a method for limiting light transmission through large area windows and the light reflection limiting in optical mirrors.

### BACKGROUND OF THE INVENTION

Optical limiters are devices designed to have high transmittance for low-level light inputs and low transmittance for high power. Since the development of the first lasers, passive optical limiters have been researched and concepts have been tested to protect optical sensors against laser peak-power induced damage. The first optical limiters for CW lasers were based on thermal lensing in absorbing bulk liquids, i.e., local heating in an imaging system reduced the index of refraction, causing “thermal blooming” and resulting in a beam that was no longer focused. Other methods have been suggested for limiting pulsed laser sources such as reverse saturable absorption, two-photon and free carrier absorption, self-focusing, nonlinear refraction and induced scattering.

Communications and other systems in medical, industrial and remote sensing applications, may handle relatively high optical powers, from microwatts up to several watts, in single fibers or waveguides. With high intensities (power per unit area) introduced into these systems, many thin film coatings, optical adhesives, and even bulk materials, are exposed to light intensity beyond their damage thresholds. Another problem is laser safety, wherein there is well-defined upper power limit allowed to be emitted from fibers into the open air. These two issues called for a passive device that limits the amount of energy propagating in a fiber/waveguide to the allowed level, this was realized and described in patent applications U.S. No. 60/725,357 and U.S. Ser. No. 10/398,859 by KiloLambda, using nanostructures and nanoparticles as non-linearity enhancing medium.

There have been many attempts to realize optical limiters, mainly for high power laser radiation, high power pulsed radiation, and eye safety devices. The techniques used in these devices were mainly:

1) Thermal change of the index of refraction n, in liquids having negative do/dT, for defocusing the light beam, e.g., in an imaging system.

2) Self-focusing or self-defocusing, due to high electric field-induced index of refraction n change, through the third order susceptibility term of the optical material, here n=n₀+n₂E² where n₀ is the index of refraction at zero electric field (no light), n₂ is the non-linear index change and E is the electric field strength of the light beam.

3) Colloidal Suspensions such as carbon black in both polar and non-polar solvents, which limit by induced scattering.

Both No. 1 and 2 of the above-mentioned techniques, require very energetic laser beams or light intensities to produce a meaningful limitation. In the first technique, the volumes of liquid to be heated are large and need high powers. Another problem with this method is that the liquid is not a good optical medium and distorts the beam. In the second technique, the n₂ coefficient is very small for usable materials and requires very high electric fields.

In the third method, the use of liquids is problematic for most applications, as suspended particles tent to form flocs of loosely bound carbon particles that sink down, needing a shake to recover the suspension. Some work has been done on using liquid crystals as limiting material; mainly for high power pulses but these materials cause noise and distortion worse than ordinary liquids due to direction fluctuations.

Limiting of relatively low optical powers, such as exist in lamp, diode or sun light, but not laser light, needs novel methods and mechanisms of limiting as well as novel geometries and optical ray passage. These are described in this invention.

### SUMMARY OF THE INVENTION

It is therefore a broad object of the present invention to provide an optical power-limiting device and a method for limiting power transmission, which ameliorates the disadvantages of the prior art devices and methods.

In accordance with the present invention, there is therefore provided an optical power-limiting device, comprising an optical-limiting solid mixture in an optical system, the optical-limiting solid mixture includes means affecting its optical properties upon being subjected to optical energy, which cause index of refraction change in the mixture due to thermal or electric field induced changes in said optical-limiting solid mixture when light is passing through.

The invention further provides structures of alternating layers of glass and optical-limiting solid mixtures, having high transparency at low light levels and low transparency when large fluxes of light pass through the layered structures and change the index of refraction of the optical-limiting solid mixture. there is therefore provided an optical power-limiting device, comprising an optical-limiting solid mixture in an optical system, the optical-limiting solid mixture includes means affecting its optical properties upon being subjected to optical energy, which cause index of refraction change in the mixture due to thermal or electric field induced changes in said optical-limiting solid mixture when light is passing through.

The invention further provides a method for limiting the power transmitted through an optical device or window where the optical-limiting solid mixture is placed. The optical-limiting solid mixture is composed of light absorbing particles, smaller than the wavelength of visible light (smaller than 0.5 microns) and preferably smaller than 0.1 microns (nano-powder) dispersed in a solid matrix material. The light absorbing particles include at least one metallic or non-metallic material selected from the group consisting of: Ag, Au, Ni, Va, Ti, Co, Cr, C, Re, Si, SmO₂ and mixtures of such materials. The solid matrix material may be a transparent or optical polymer or inorganic glass material, e.g., polymethylmethacrylate (“PMMA”) and its derivatives, epoxy resins, glass, spin-on Glass (“SOG”), or other sol-gel materials. The optical-limiting function begins with light absorption in the dispersed powder particles, each according to its absorption spectrum. When the absorbed light heats the particles, they conduct heat to their surroundings, These hot volumes can decrease the light transmission through the optical-limiting solid mixture by several mechanisms, one of which is scattering due to the refractive index spatial fluctuations created by the hot particle and its surrounding medium of a given, positive or negative, index change with temperature (dn/dT). Another mechanism is reflection due to index changes in the alternating layers of regular glass and optical-limiting solid mixture, that is hotter in has a different index of refraction The light that is not scattered or reflected continues along the optical path having lower, “limited” power. When the incident power is reduced, the scattering volume, which surrounds each absorbing particle, diminishes or the index change in the alternating layers is diminishing. The transmittance through the optical-limiting solid mixture returns to its original value, and the scattering and reflection processes decreases to negligible values. The process may be repeated many times without any permanent damage up to energies that are an order of magnitude or more, larger than the transmitted power limit.

The light-absorbing particles are dispersed in a transparent matrix such as a monomer, which is subsequently polymerized. There are many techniques for preparing such dispersions, such as with the use of dispersion and deflocculation agents added to the monomer mix. One skilled in the art of polymer and colloid science is able to prepare this material for a wide choice of particles and monomers. Similarly, techniques are well known in the art to prepare composite materials with dispersed sub-micron particles in inorganic glass matrices.

The optical power-limiting device or window can offer the following advantages and properties:

1. The operation of the limiter-window is passive; no external power is required.

2. The limiter-window operates for many cycles (e.g., tens of thousands), limiting at high input powers and returning to its original, non-limiting state when the input light power is lowered or shut off

3. The limiter-window may be activated by a wide range of wavelengths, e.g., visible, or near infrared.

4. The limiter-window withstands high intensities a few (e.g., ×10) times higher than the limiting threshold.

5. The limiter-window has relatively fast (e.g., seconds region and below) response.

6. The limiter-window has high light transmission (e.g., 1 dB or less insertion loss) at intensities below the power limit.

7. The limiter-window is suitable for use as a large window pan.

Some uses of the limiter-window may be in the construction and vehicle industry, e.g., limiting the amount of solar light through windows and sunroofs. Also, transmittance control of solar light into cars, airplanes or other forms of transportation through windows and sunroofs. In optical large aperture devices as mirrors e.g. rear view mirrors in cars.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross-sectional view of a limiter-window device according to the present invention.

FIG. 2 is a cross-sectional view of a limiter-window device and its limiting action according to the present invention.

FIG. 3 is a cross-sectional view of a perpendicular layered limiter-window device according to the present invention.

FIG. 4 is a cross-sectional view of a slope layered limiter-window device according to the present invention.

FIG. 5 is a cross-sectional view of a micro lens array limiter-window device according to the present invention.

FIG. 6 is an additional cross-sectional view of a micro lens array limiter-window device according to the present invention.

### DETAILED DESCRIPTION OF PREFERRED EMBODIMENTS

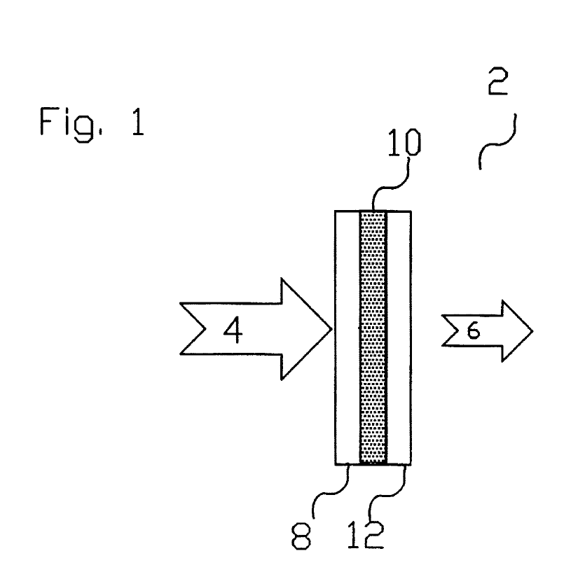

In the limiter-window configuration illustrated in FIG. 1, light enters a limiter-window 2 in direction 4 and impinges on a plane glass layer 8 and further proceeds to optical-limiting solid mixture 10 placed between plane glass layers 8 and 12. The optical-limiting solid mixture 10 is composed of a suspension of light absorbing particles, smaller than the wavelength of visible light (smaller than 0.5 microns) and preferably smaller than 0.1 microns (nano-powder) equally distributed or suspended in a solid, e.g., polymer, material having a large negative index change with temperature (dn/dT). The absorbing material include at least one metallic or non-metallic material selected from the group consisting of: Ag, Au, Ni, Va, Ti, Co, Cr, C, Re, Si and mixtures of such materials. The polymer host material, having a large (dn/dT), may be: PMMA or its derivatives, polymer based on epoxy resins, glass, spin on glass (SOG) or other sol-gel materials. The optical-limiting function begins with light absorption in the suspended small particles, according to their absorption spectra. When the particles are heated they conduct heat to their surroundings, leaving hot spots in the volume surrounded by a decreasing temperature gradient in their neighborhood. These hot volumes can decrease the light transmission through the optical-limiting solid mixture 10 by several mechanisms, one of which is scattering due to the refractive index spatial fluctuations created by the hot particle and its surrounding medium. The scattered light is partially back reflected and partially side reflected, leaving a smaller amount of light 6 to exit the limiter-window. The light 6 that is not scattered continues along the optical path and has lower, “limited” power. When the incident power is reduced, the scattering volume, which surrounds each absorbing particle, diminishes. The transmission through the optical-limiting solid mixture 10 returns to its original value, as the scattering process decreases to negligible values. The process may be repeated many times without any permanent damage up to energies that are an order of magnitude or more, larger than the transmitted power limit.

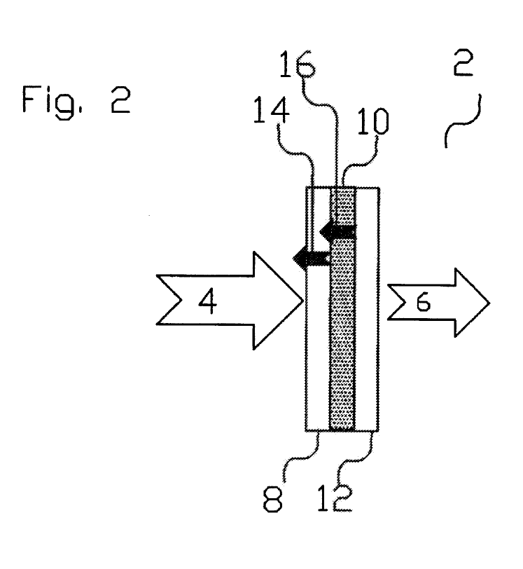

FIG. 2 illustrates a limiter-window device 2 where light enters in direction 4 and impinges on a plane glass layer 8 and further proceeds to optical-limiting solid mixture 10 placed between plane glass layers 8 and 12. The optical-limiting solid mixture 10 is composed of relatively dense suspension of light absorbing particles, smaller than the wavelength of visible light (smaller than 0.5 microns) and preferably smaller than 0.1 microns (nano-powder) equally distributed or suspended in a solid, e.g., polymer, material having a large negative index change with temperature (dn/dT). The absorbing material include at least one metallic or non-metallic material selected from the group consisting of: Ag, Au, Ni, Va, Ti, Co, Cr, C, Re, Si and mixtures of such materials. The polymer host material, having a large (dn/dT), may be: PMMA or its derivatives, polymer based on epoxy resins, glass, spin on glass (SOG) or other sol-gel materials. The optical-limiting function begins with light absorption in the suspended small particles, according to their absorption spectra. When the relatively dense particles are heated, they conduct heat to their surroundings, heating up the volume 10 entirely; this volume is surrounded by a higher index glass planes 8 and 12. This hot volume 10 can decrease the light transmission through the limiter window 2 as due to the index difference light is back reflected at the interfaces depicted by arrows 14 and 16, leaving a smaller amount of light 6 to exit the limiter-window. The light 6 that is not reflected continues along the optical path and has lower, “limited” power. When the incident power is reduced, the volume, which surrounds the absorbing particles, reduces its temperature and index difference and the back reflection 14 and 16 diminishes. The transmission through the optical-limiting solid mixture 10 returns to its original value

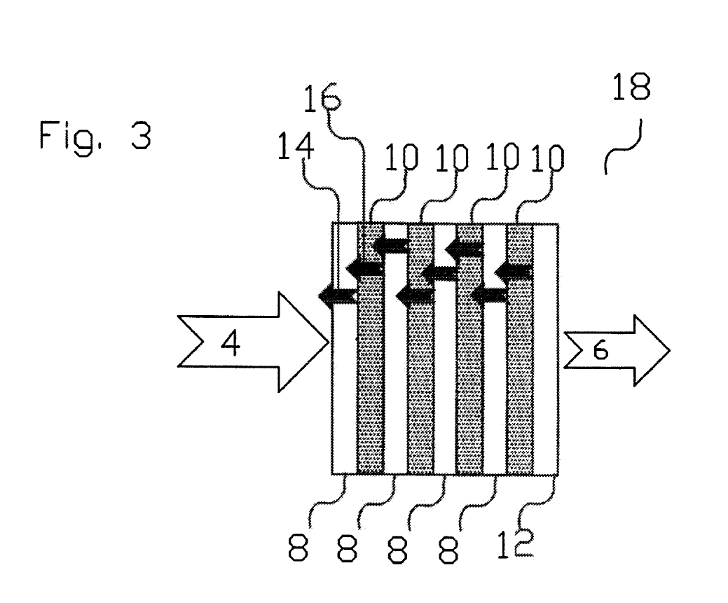

FIG. 3 illustrates a modification of the embodiment of FIG. 2 where the optical-limiting solid mixture 10 is layered and the combination of the glass 8 optical-limiting solid mixture 10 and again glass 8 is repeated many times. Thus increasing the back reflected light 14 and 16 many (e.g. 10 times).

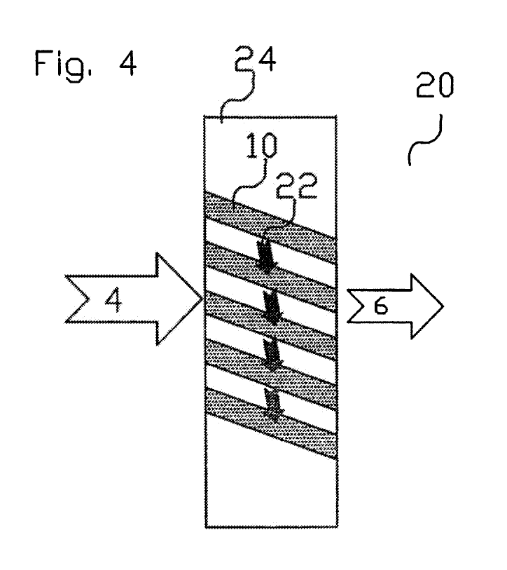

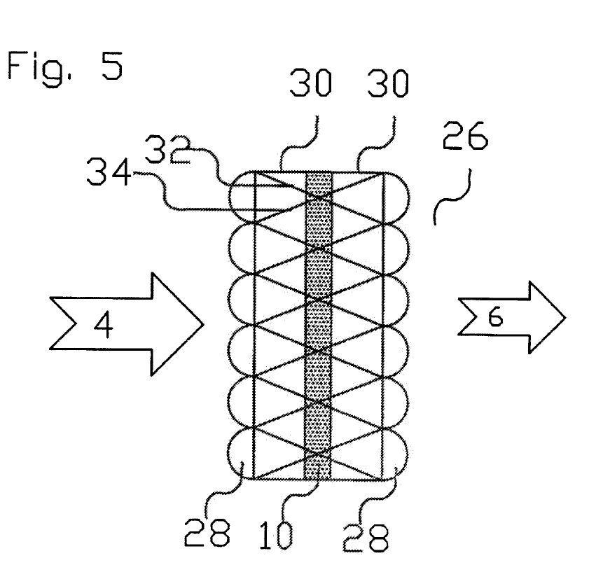

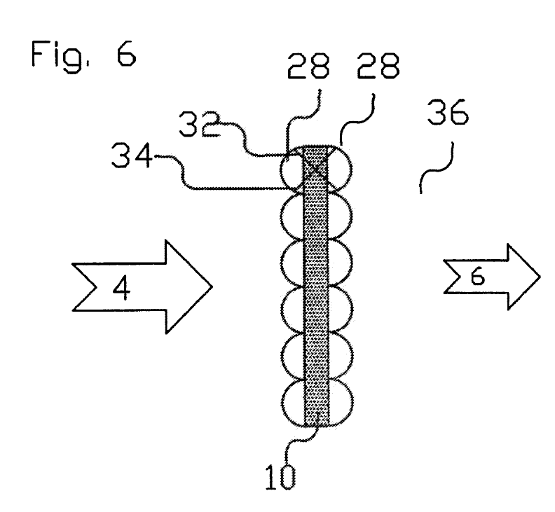

FIG. 4 illustrates a modification of the embodiment of FIG. 2 where the optical-limiting solid mixture 10 is layered and tilted at an angle, and the combination of the glass 8 optical-limiting solid mixture 10 and again glass 8 is repeated many times. Thus increasing the side reflected light 22 many (e.g. 10) times. FIG. 5 is a cross-sectional view of the micro lens structure 26 where micro lens array 28 is the first surface impinged by the light beam 4, where the light continues along rays 32 and 34 toward a focus inside the optical-limiting solid mixture 10. The increased light intensity at this focus is creating effects in the optical-limiting solid mixture 10. The optical-limiting solid mixture 10 is composed of a suspension of light absorbing particles, smaller than the wavelength of visible light (smaller than 0.5 microns) and preferably smaller than 0.1 microns (nano-powder) equally distributed or suspended in a solid, e.g., polymer, material having a large negative index change with temperature (dn/dT). The absorbing material include at least one metallic or non-metallic material selected from the group consisting of: Ag, Au, Ni, Va, Ti, Co, Cr, C, Re, Si and mixtures of such materials. The polymer host material, having a large (dn/dT), may be: PMMA or its derivatives, polymer based on epoxy resins, glass, spin on glass (SOG) or other sol-gel materials. The optical-limiting function begins with light absorption in the suspended small particles, according to their absorption spectra. When the particles are heated they conduct heat to their surroundings, leaving hot spots in the volume surrounded by a decreasing temperature gradient in their neighborhood. These hot volumes can decrease the light transmission through the optical-limiting solid mixture 10 by several mechanisms, one of which is scattering due to the refractive index spatial fluctuations created by the hot particle and its surrounding medium. The scattered light is partially back reflected and partially side reflected, leaving a smaller amount of light 6 to exit the limiter-window. Another mechanism is heat induced lensing where a radial heat gradient in the focal area is causing beam spread due to the creation of a negative lens. Only part of the passing light, in this case, will reach the opposite lenslet 28 and will exit in direction 6. The light 6 that is not scattered or spread by the thermal lens, continues along the optical path and has lower, “limited” power. When the incident power is reduced, the scattering volume, which surrounds each absorbing particle, diminishes. The transmission through the optical-limiting solid mixture 10 returns to its original value, as the scattering process decreases to negligible values. The process may be repeated many times without any permanent damage up to energies that are an order of magnitude or more, larger than the transmitted power limit. A spacer 30 is introduced between the lenslet array 28 and optical-limiting solid mixture 10, this can be of solid transparent material, e.g. glass of gas transparent material e.g. air. The lenslet arrays 28 can be mounted directly on the optical-limiting solid mixture 10 as seen in FIG. 6, where the common focus of the two lenslet arrays is in the optical-limiting solid mixture 10 as shown on the cross over of rays 32 and 34.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A passive optical power limiting window comprising:
a transparent optical input element,
a transparent optical output element, and
a power-limiting element disposed between said input and output elements for transmitting optical light from said input element to said output element, said optical power-limiting element comprising an optical-limiting solid mixture containing particles of at least one material that produces reversible thermal changes in response to light above a predetermined optical power level, thereby changing the optical transmission properties of said power-limiting element.

2. The optical power limiter of claim 1, wherein said optical-limiting solid mixture comprises light-absorbing particles dispersed in an optically transparent matrix material.

3. The optical power limiter of claim 2, wherein said optically transparent matrix material is selected from the group consisting of polymeric material and inorganic glass material.

4. The optical power limiter of claim 2, wherein said optically transparent matrix material is selected from the group consisting of polymethylmethacrylate and its derivatives, epoxy resins, glass, sol gel derived material and spin-on glass.

5. (canceled)

6. The optical power limiter of claim 2, wherein said light-absorbing particles are at least one material selected from the group consisting of Ag, Au, Ni, Va, Ti, Co, Cr, C, Re, Si and SmO2.

7. An optical window-limiter, in which said solid mixture is packaged between two flat transparent plates.

8. The optical limiter of claim 7, wherein said solid mixture is packaged in alternating layers parallel to the external plates.

9. The optical limiter of claim 7, wherein said solid mixture is packaged in alternating layers tilted to the external plates.

10. The optical limiter of claim 7, wherein said solid mixture is packaged in between two lenslet arrays having a common focus inside the limiting mixture.

11. An optical power-limiting window method comprising:
transmitting optical signals through an input optical transmission element and a power-limiting element to an output optical transmission element, and
producing reversible thermal changes in said power-limiting element in response to light above a predetermined optical power level, thereby changing the optical transmission properties of said power-limiting element.

12. The optical power-limiting method of claim 11, wherein said power-limiting element comprises an optical-limiting solid mixture containing particles of at least one material that produces reversible thermal changes in response to light above a predetermined optical power level.

13. The optical power-limiting method of claim 12, wherein said optical-limiting solid mixture comprises light-absorbing particles dispersed in an optically transparent matrix material.

14. The optical power-limiting method of claim 13, wherein said optically transparent matrix material is a polymeric material.

15. The optical power-limiting method of claim 13, wherein said optically transparent matrix material is at least one material selected from the group consisting of polymethylmethacrylate and its derivatives, based on epoxy resins, glass, sol gel derived and spin-on glass.

16. The optical power-limiting method of claim 13, wherein said optically transparent matrix material is an inorganic glass material.

17. The optical power-limiting method of claim 12, wherein said light-absorbing particles are at least one material selected from the group consisting of Ag, Au, Ni, Va, Ti, Co, Cr, C, Re, Si and SmO₂.

18. The optical power-limiting method of claim 12, in which said solid mixture is packaged between two flat transparent plates.

19. The optical limiter of claim 18, wherein said solid mixture is packaged in alternating layers parallel to the external plates.

20. The optical limiter of claim 18, wherein said solid mixture is packaged in alternating layers tilted to the external plates.

21. The optical limiter of claim 18, wherein said solid mixture is packaged in between two lenslet arrays having a common focus inside the limiting mixture.
